(19) United States
(12) Patent Application Publication
(10) Pub. No.: US 2023/0399548 A1
(43) Pub. Date: Dec. 14, 2023

(54) BONDING FILM FOR HIGH-SPEED COMMUNICATION BOARD

(71) Applicant: SHIN-ETSU CHEMICAL CO., LTD., Tokyo (JP)

(72) Inventors: Toshio SHIOBARA, Tokyo (JP); Yoshihiro TSUTSUMI, Annaka-shi (JP)

(73) Assignee: SHIN-ETSU CHEMICAL CO., LTD., Tokyo (JP)

(21) Appl. No.: 18/322,144

(22) Filed: May 23, 2023

(30) Foreign Application Priority Data
Jun. 8, 2022 (JP) 2022-092619

(51) Int. Cl. C09J 7/38; C08J 5/24; C09J 7/25

(52) U.S. Cl. CPC C09J 7/38; C08J 5/244; C09J 7/255; C08J 2379/08; C09J 2479/08

(57) ABSTRACT

Provided is a bonding film for a high-speed communication board that is superior in adhesion to a conductor layer without requiring a specifical treatment process for improving an adhesiveness between the smooth conductor layer and an insulation layer in the production of a circuit board such as a multilayered printed-wiring board and a flexible printed-wiring board. The bonding film is a curable adhesive layer-containing bonding film for a high-speed communication board, which includes:
a curable resin composition layer containing a curable resin composition; and
a curable adhesive composition layer that is laminated on one or both surfaces of the curable resin composition layer, contains a bismaleimide resin-containing curable adhesive composition, and has a thickness of 1 to 100 μm.

### BACKGROUND OF THE INVENTION

### Field of the Invention

The present invention relates to a bonding film for a high-speed communication board that is superior in adhesion to a copper foil with a small surface roughness; and a production method thereof.

### Background Art

Circuit boards such as a multilayered printed-wiring board and a flexible printed-wiring board that are widely used in various electronic devices are now required to have thinner layers and finer patterns as electronic devices themselves are becoming smaller and more sophisticated.

Nowadays, with the prevalence of higher speed communication such as 5G, strongly demanded are a high-speed communication board and an antenna board that exhibit low degrees of transmission loss even at high frequencies such as those of millimeter waves. Further, in the cases of information terminals such as smartphones, significant progresses are being made in acquiring a wiring board that is packaged at a higher density and is made ultrathin. Meanwhile, due to skin effect, transmission signals tend to propagate on a conductor surface more intensely as frequency gets higher e.g. as high as that of millimeter waves; transmission loss increases as the roughness of the conductor surface becomes larger.

Conventionally, a copper foil with a large surface roughness was used to improve an adhesion strength between a bonding film and the copper foil serving as a conductor.

In recent years, there has been an increasing demand for handling high-speed signals via a high-density micro wiring; there has been an increasing demand for smoothing the conductor surface without roughening the same as much as possible, and maintaining a high adhesion strength to an insulation resin. In this regard, there are disclosed a method of treating the conductor surface with a silane coupling agent (Japanese Translation of PCT International Application Publication No. JP-T-2004-536220), and a method of forming an azole compound film on the conductor surface (JP-A-2002-321310), so that a high adhesion can be achieved via chemical bonding instead of a physical anchor effect.

Further, there is also known a method where a circuit is formed after bonding a copper foil to a film. In this method, there is proposed an adhesion improver layer-containing adhesion film produced by laminating, on a film made of a curable resin composition, an adhesion improver layer containing a compound selected from the group consisting of a silane coupling agent, an azole compound, a triazine compound and a porphyrin compound, for the purpose of improving an adhesiveness between the copper foil and the film (JP-A-2010-120192).

However, even when using such adhesion film that employs an adhesion improver, there is still observed an insufficient adhesion strength with respect to a smooth copper foil intended for millimeter waves.

Further, it is generally known that an adhesion improver can be added to a resin composition serving as an insulation layer; however, in the case of a smooth conductor, even by adding an adhesion improver, there is still a problem such as one that negative impacts will be caused on a water absorbability, an insulation property or other properties of a cured product of the resin composition due to a poor preservation stability of such resin composition that is triggered by the fact that the adhesion improver added and the resin composition shall react with each other.

### SUMMARY OF THE INVENTION

It is an object of the present invention to provide a bonding film for a high-speed communication board that is superior in adhesion to a conductor with a small surface roughness in the production of a circuit board such as a multilayered printed-wiring board and a flexible printed-wiring board.

After diligently conducting a series of studies, the inventors of the present invention found that there could be formed an insulation layer superior in adhesion to a conductor by alternatively using a high-speed communication board bonding film that has been produced by previously laminating a curable resin composition layer (insulation layer) formed on a support and a curable adhesive composition layer (adhesion layer) with which a strong adhesion can be achieved with respect to a conductor having a smooth surface (e.g. copper foil), instead of by directly forming an adhesion improver layer on a circuit board.

That is, the present invention is as follows.

[1]

A curable adhesive layer-containing bonding film for a high-speed communication board, comprising:
a curable resin composition layer containing a curable resin composition; and
a curable adhesive composition layer that is laminated on one or both surfaces of the curable resin composition layer, contains a bismaleimide resin-containing curable adhesive composition, and has a thickness of 1 to 100 μm.
   [2]

The bonding film for a high-speed communication board according to [1], wherein the bismaleimide resin includes a bismaleimide resin represented by the following formula (1):

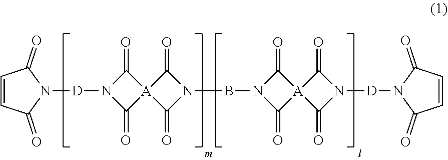

wherein A independently represents a tetravalent organic group having a cyclic structure; B independently represents a divalent hydrocarbon group having 6 to 60 carbon atoms; D independently represents a divalent hydrocarbon group having 6 to 200 carbon atoms, where at least one D represents a dimer acid frame-derived hydrocarbon group; m is 0 to 100, and l is 0 to 200, where m=l=0 is also included; no restrictions are imposed on an order of each repeating unit identified by m and l, and a bonding pattern may be alternate, block or random.

[3]

The bonding film for a high-speed communication board according to [1], wherein the curable adhesive composition is capable of adhering to a copper foil having a surface roughness (Rz) of not larger than 1.8 μm.

[4]

The bonding film for a high-speed communication board according to [2], wherein the curable adhesive composition contains an inorganic filler.

[5]

The bonding film for a high-speed communication board according to [1], wherein the curable adhesive composition layer is a prepreg with a quartz glass cloth being impregnated with a curable adhesive composition containing a bismaleimide resin represented by the following formula (1) and an inorganic filler

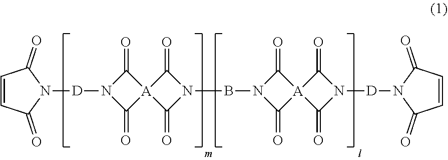

wherein A independently represents a tetravalent organic group having a cyclic structure; B independently represents a divalent hydrocarbon group having 6 to 60 carbon atoms; D independently represents a divalent hydrocarbon group having 6 to 200 carbon atoms, where at least one D represents a dimer acid frame-derived hydrocarbon group; m is 0 to 100, and l is 0 to 200, where m=l=0 is also included; no restrictions are imposed on an order of each repeating unit identified by m and l, and a bonding pattern may be alternate, block or random.

[6]

The bonding film for a high-speed communication board according to [5], wherein the prepreg has a dielectric tangent of not larger than 0.002 at 10 GHz.

[7]

The bonding film for a high-speed communication board according to [1], wherein the curable adhesive composition layer has a thickness of 1 to 50 μm.

[8]

The bonding film for a high-speed communication board according to [1], wherein the curable resin composition contains an epoxy resin and/or a bismaleimide resin; and a curing agent.

[9]

The bonding film for a high-speed communication board according to [1], wherein the curable resin composition layer has a thickness of 1 to 100 μm.

[10]

The bonding film for a high-speed communication board according to [1], wherein the curable resin composition layer is a prepreg with a quartz glass cloth being impregnated with a curable resin composition.

[11]

The bonding film according to [1] with the curable adhesive composition layer being laminated on one surface of the curable resin composition layer, wherein
a support is provided on a surface of the curable resin composition layer that is not in contact with the curable adhesive composition layer, and
another support is provided on a surface of the curable adhesive composition layer that is not in contact with the curable resin composition layer.
   [12]

The bonding film for a high-speed communication board according to [11], wherein the support is a polyethylene terephthalate film.

[13]

The bonding film for a high-speed communication board according to [12], wherein the support has a thickness of 10 to 70 μm.

[14]
A method for producing a bonding film for a high-speed communication board, comprising a step of laminating a curable resin composition layer formed on a support and a curable adhesive composition layer formed on a support.

According to the present invention, by using a bonding film having a laminated curable adhesive composition layer (adhesion layer) that is to be bonded to a conductor whose roughness has been lowered by a treatment (a conductor with a small surface roughness), a curable resin composition layer (insulation layer) superior in adhesion to the conductor can be easily formed on the conductor without performing a special treatment process on the conductor. Further, by using a bonding film with a curable adhesive composition layer (adhesion layer) being laminated, there is no need to add an adhesion improver into a resin composition, which will avoid deterioration in preservation stability of the resin composition when stored.

### DETAILED DESCRIPTION OF THE INVENTION

The present invention is described in detail hereunder with reference to a preferable embodiment thereof.

A bonding film of the present invention for use in a high-speed communication board is mainly characterized in that a curable resin composition layer and a curable adhesive composition layer forming a strong adhesion with a conductor are laminated on a support(s).

Using the bonding film of the present invention, an insulation layer superior in adhesion to a conductor can be easily formed on such conductor without performing a special treatment on the conductor, via a step of peeling off the support as appropriate and a step of curing the curable resin composition layer (insulation layer) and the curable adhesive composition layer (adhesion layer); the bonding film of the present invention allows a circuit board such as a multilayered printed-wiring board and a flexible printed-wiring board to be produced efficiently.

While a copper foil as a conductor can be categorized into an electrolytic foil and a rolled foil, the product of the present invention can be applied to either type of copper foil. The surface roughness (Rz) of a surface of the copper foil that is to be adhered to the curable adhesive composition layer (adhesion layer) is not larger than 1.8 μm, preferably not larger than 1.0 μm. If the surface roughness is greater than 1.8 μm, a significant transmission loss will occur, which may lead to an unsatisfactory practical performance in terms of a conductor for use in a high-speed communication board.

The surface roughness (Rz) refers to a value measured in accordance with JIS B0601-2001.

### Support

In the case of the bonding film of the present invention, any support may be used so long as the support used is a film having a self-supporting property or a sheet-shaped member. There are no particular restrictions on the material of such support; in terms of handling property, cost, versatility, etc., preferred are flexible plastic sheets such as polyethylene terephthalate, polyethylene naphthalate, polyimide, polyamideimide, polyamide, polytetrafluoroethylene, and polycarbonate. Among them, polyethylene terephthalate is particularly preferred as being inexpensive.

The support may be one that has already been subjected to a surface treatment such as a matte treatment and a corona treatment. Further, the support may also be one that has been subjected to a mold release treatment with the aid of a mold release agent such as a silicone resin-based mold release agent, an alkyd resin-based mold release agent, and a fluorine resin-based mold release agent.

Moreover, the support preferably has a thickness of 10 to 70 μm, more preferably 15 to 70 μm. An extremely small thickness may lead to a poor handling property, a deteriorated peelability of the support, and defects in forming a smooth metal film layer. Further, an extremely large thickness may lead to a high cost.

Also, a protective film (cover film) may be provided on a surface of the bonding film that is not in contact with the support.

### Curable Adhesive Composition Layer

A curable resin (curable adhesive) contained in a curable adhesive composition used in the curable adhesive composition layer (adhesion layer) is to improve an adhesion between a metal as a conductor used (e.g. metal thin film) and a resin composition; the following bismaleimide resin superior in adhesion to a metal film whose roughness has been lowered by a treatment is suitable for bonding a metal thin film (e.g. copper foil) and a resin composition (e.g. epoxy resin composition).

As the bismaleimide resin used in the present invention, a bismaleimide resin represented by the following general formula (1) is preferred as being superior in heat resistance, low elasticity, toughness and adhesiveness.

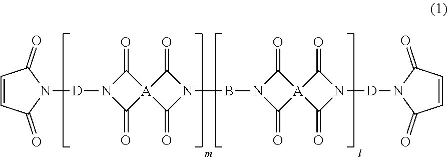

In the formula (1), A independently represents a tetravalent organic group having a cyclic structure; B independently represents a divalent hydrocarbon group having 6 to 60 carbon atoms; D independently represents a divalent hydrocarbon group having 6 to 200 carbon atoms, where at least one D represents a dimer acid frame-derived hydrocarbon group; m is 0 to 100, and l is 0 to 200, where m=l=0 is also included; no restrictions are imposed on an order of each repeating unit identified by m and l, and a bonding pattern may be alternate, block or random.

The bismaleimide resin represented by the formula (1) has at least one dimer acid frame-derived hydrocarbon group.

A dimer acid refers to a liquid dibasic acid whose main component is a dicarboxylic acid having 36 carbon atoms, which is produced by dimerizing an unsaturated fatty acid having 18 carbon atoms and employing a natural substance such as a vegetable fat or oil as its raw material. A dimer acid frame may contain multiple structures as opposed to one single type of frame, and there exist several types of isomers. Typical dimer acids are categorized under the names of (a) linear type, (b) monocyclic type, (c) aromatic ring type, and (d) polycyclic type.

In this specification, a dimer acid frame refers to a group induced from a dimer diamine having a structure established by substituting the carboxy groups in such dimer acid with primary aminomethyl groups. That is, as a dimer acid frame, it is preferred that the above bismaleimide resin have a group obtained by substituting the two carboxy groups in any of the following dimer acids (a) to (d) with methylene groups. Further, as for the dimer acid frame-derived hydrocarbon group in the above bismaleimide resin, more preferred from the perspectives of heat resistance and reliability of a cured product are those having a structure with a reduced number of carbon-carbon double bonds in the dimer acid frame-derived hydrocarbon group due to a hydrogenation reaction.

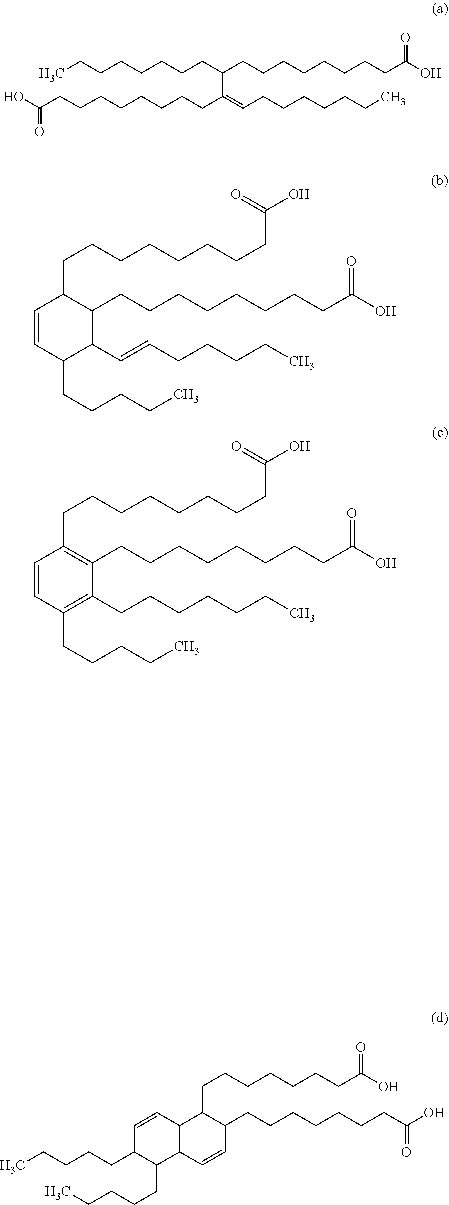 [SMILES: CCCCCCC/C=C(/CCCCCCCCC(=O)O)C(CCCCCCCC)CCCCCCCCC(=O)O ; CCCCC/C=C/C1C(CCCCC)C=CC(CCCCCCCCC(=O)O)C1CCCCCCCCC(=O)O ; CCCCCCCc1c(CCCCC)ccc(CCCCCCCCC(=O)O)c1CCCCCCCCC(=O)O ; CCCCCC1C=CC2C(C=CC(CCCCCCCC(=O)O)C2CCCCCCCC(=O)O)C1CCCCC]

A in the formula (1) representing the above bismaleimide resin independently represents a tetravalent organic group having a cyclic structure; it is preferred that Abe any one of the tetravalent organic groups represented by the following structural formulae.

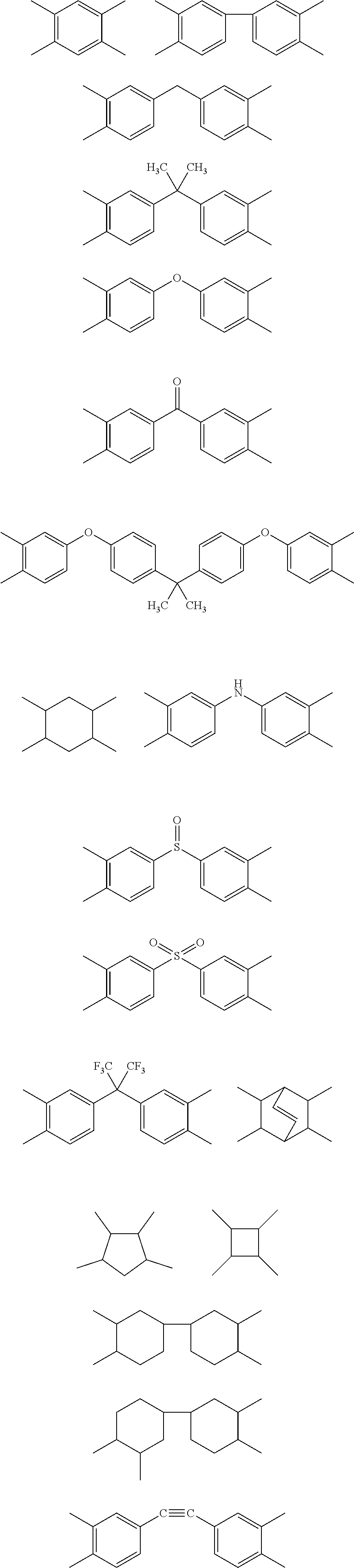

Bonds in the above structural formulae that are yet unbonded to substituent groups are to be bonded to carbonyl carbons forming cyclic imide structures in the formula (1).

B in the formula (1) independently represents a divalent hydrocarbon group having 6 to 60, preferably 7 to 50, more preferably 8 to 45 carbon atoms. Particularly, it is preferred that B be a branched divalent hydrocarbon group with at least one hydrogen atom in the above divalent hydrocarbon group being substituted by an alkyl or alkenyl group(s) having 6 to 60, preferably 7 to 50, more preferably 8 to 45 carbon atoms. The branched divalent hydrocarbon group may be either a saturated aliphatic hydrocarbon group or an unsaturated hydrocarbon group, and may also have an alicyclic structure or an aromatic ring structure in the midway of the molecular chain.

D in the formula (1) independently represents a divalent hydrocarbon group having 6 to 200, preferably 8 to 100, more preferably 10 to 50 carbon atoms. Similarly, it is preferred that D be a branched divalent hydrocarbon group with at least one hydrogen atom in the above divalent hydrocarbon group being substituted by an alkyl or alkenyl group(s) having 6 to 200, preferably 8 to 100, more preferably 10 to 50 carbon atoms. The branched divalent hydrocarbon group may be either a saturated aliphatic hydrocarbon group or an unsaturated hydrocarbon group, and may also have an alicyclic structure or an aromatic ring structure in the midway of the molecular chain.

Likewise, one specific example of the branched divalent hydrocarbon group may be a divalent hydrocarbon group derived from a dual-end diamine called dimer diamine. Thus, it is particularly preferred that D be a group obtained by substituting the two carboxy groups in any of the dimer acids represented by (a) to (d) with methylene groups, and there is at least one such dimer acid-derived frame in each molecule.

In the formula (1), m is 0 to 100, and l is 0 to 200, where m=l=0 is also included. Preferably, m and n are each 0 to 20. If m and n are both too large, a solubility and a fluidity will deteriorate, which may lead to a poor moldability in terms of lamination, impregnation or the like.

As a typical example of the bismaleimide resin of the formula (1), there may be listed a resin represented by the following formula (2) (SLK-6895 by Shin-Etsu Chemical Co., Ltd.) and a resin represented by the following formula (3) (SLK-3000 by Shin-Etsu Chemical Co., Ltd.).

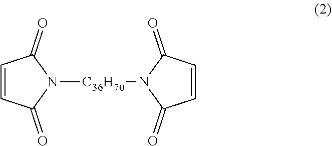

(C₃₆H₇₀ is a dimer acid frame-derived hydrocarbon group)

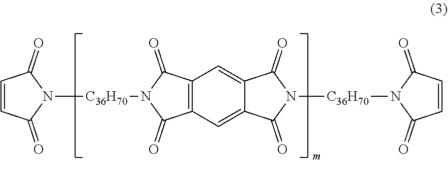

m≈5 (Average value)

One kind of the bismaleimide resin represented by the formula (1) may be used alone, or two or more kinds thereof may be used in combination. As the bismaleimide resin, the SLK-2000 series (by Shin-Etsu Chemical Co., Ltd.) or the like is also available other than the abovementioned SLK-6895 (by Shin-Etsu Chemical Co., Ltd.) and SLK-3000 (by Shin-Etsu Chemical Co., Ltd.).

The bismaleimide resin is preferably contained in the curable adhesive composition by an amount of 10 to 99.9% by mass, more preferably 20 to 99.5% by mass, even more preferably 50 to 99% by mass.

The curable adhesive composition layer may also be a prepreg prepared by impregnating a sheet-shaped reinforcement base material such as a glass cloth, a quartz glass cloth, a carbon fiber woven cloth, and a carbon nanotube unwoven cloth with a resin such as a bismaleimide resin. As the sheet-shaped reinforcement base material, a quartz glass cloth is preferred as having a small dielectric tangent and exhibiting a low degree of transmission loss. A quartz glass cloth has dielectric properties more excellent than those of, for example, a NE glass known as a low-dielectric glass. It is preferred that the quartz glass cloth be one exhibiting a dielectric tangent of not larger than 0.002, more preferably not larger than 0.001, even more preferably not larger than 0.0008, particularly preferably not larger than 0.0004, in a frequency range of 10 to 70 GHz. In this way, the adhesion layer that is to be bonded to the copper foil whose roughness has been lowered by a treatment will exhibit an extremely low degree of transmission loss.

An impregnation amount and lamination amount of the curable resin (curable adhesive) to the sheet-shaped reinforcement base material is 10 to 200 parts by mass per 100 parts by mass of the reinforcement base material.

The curable adhesive composition layer has a thickness of 1 to 100 μm, preferably 1 to 50 μm. An extremely small thickness may lead to an insufficient adhesion-improving effect; an extremely large thickness will cause the curable resin (curable adhesive) to flow out at the time of performing pressure molding, which may make it impossible to obtain a favorable product as it is difficult to control the thickness.

The curable adhesive composition used in the curable adhesive composition layer (adhesion layer) may contain the following curing agent(s). The curing agent is to cure the bismaleimide resin in the curable adhesive composition layer, and can be any curing agent so long as it is capable of promoting a cross-linking reaction; there may be used a radical polymerization initiator, an anionic polymerization initiator or the like. For example, there may be listed a radical polymerization initiator such as an organic peroxide, hydroperoxide and azoisobutyronitrile; and an anionic polymerization initiator(s) such as imidazoles, tertiary amines, quaternary ammonium salts, boron trifluoride-amine complex, organophosphines, and organophosphonium salts. Among them, an organic peroxide is preferred as a radical polymerization initiator, and imidazoles and tertiary amines are preferred as anionic polymerization initiators. Preferable examples of an organic peroxide include dicumyl peroxide, t-butyl peroxybenzoate, t-amyl peroxybenzoate, dibenzoyl peroxide, and dilauroyl peroxide. Preferable examples of imidazoles include imidazole, 2-methylimidazole, 2-ethylimidazole, 2-heptadecylimidazole, 1,2-dimethylimidazole, 2-ethyl-4-methylimidazole, 2-undecylimidazole, 2-phenylimidazole, 2-phenyl-4-methylimidazole, 1-benzyl-2-methylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 2-phenyl-4,5-dihydroxymethylimidazole, and 2-phenyl-4-methyl-5-hydroxymethylimidazole.

One kind of curing agent may be used alone, or two or more kinds thereof may be used in combination.

The curing agent is added in an amount of 0.05 to 10 parts by mass, preferably 0.1 to 5 parts by mass, per 100 parts by mass of the organic resin content in the curable adhesive composition. When the amount of the curing agent added is out of these ranges, the cured product may exhibit a poor balance between heat resistance and moisture resistance, and a curing speed at the time of molding may be either extremely slow or extremely fast.

The curable adhesive composition may also contain, for example, a phenolic resin, a silicone resin, a cyanate resin, a reactive PPE, a maleimide compound, a benzoxazine compound, an allyl group-containing compound, an unsaturated polyester resin, or even a hybrid resin composed of multiple kinds of these resins and compounds.

The curable adhesive composition may also contain a silane coupling agent such as those shown below.

The silane coupling agent may be a known and commonly used one, examples of which may include vinyltrimethoxysilane, vinylphenyltrimethoxysilane, γ-methacryloxypropyltrimethoxysilane, γ-glycidoxypropyltrimethoxysilane, 4-glycidylbutyltrimethoxysilane, γ-aminopropyltriethoxysilane, N-β(aminoethyl)γ-aminopropyltrimethoxysilane, N-3-(4-(3-aminopropoxy)butoxy)propyl-3-aminopropyltrimethoxysilane, N-phenyl-γ-aminopropyltrimethoxysilane, imidazole silane, triazine silane, and γ-mercaptopropyltrimethoxysilane.

Further, the curable adhesive composition may contain an inorganic filler for achieving a lower thermal expansion after curing. Examples of such inorganic filler include silica, alumina, mica, mica, a silicate salt, barium sulfate, magnesium hydroxide and titanium oxide, of which preferred are silica and alumina, and particularly preferred is silica.

The inorganic filler may be spherical or crushed particles. Particularly, a spherical silica made of a molten silica is preferred; while those having an average particle size of not larger than 10 μm will suffice, an average particle size of 0.1 to 5 μm is preferred, and a finer average particle size of not larger than 0.6 μm is even more preferred, in terms of insulation reliability, thicknesses of the resin and adhesion layers, and appearance. In the meantime, while there are no particular restrictions on the lower limit of the average particle size, it is preferred that the average particle size be 0.1 μm or larger. An average particle size of smaller than 0.1 m may lead to a poor workability due to the occurrence of thixotropy that is triggered by a larger surface area of the particles.

An inorganic filler whose surface has been treated with the aforementioned silane coupling agent is preferred as the surface of the inorganic filler and the resin can thus be strongly bonded together.

Such inorganic filler is added in an amount of 0.2 to 10.0 parts by mass, particularly preferably 1.0 to 5.0 parts by mass, per 100 parts by mass of a total amount of the curable resin(s). With an added amount of smaller than 0.2 parts by mass, the resin and the surface of the inorganic filler cannot be strongly bonded together; an added amount of larger than 10 parts by mass may for example cause the coupling agent to ooze out, and lead to a poor appearance due to the occurrence of voids that is triggered by a larger volatilization amount at the time of drying. Here, a surface treatment method using the coupling agent can be appropriately selected, and there are no particular restrictions imposed thereon.

The inorganic filler is preferably contained in the curable adhesive composition by an amount of 0 to 60% by mass, more preferably 20 to 50% by mass. The absence of an inorganic filler leads to a larger thermal expansion rate of the resin, and thus contributes to peeling due to a thermal stress in the adhesive interface. Further, if the inorganic filler is contained by an amount of larger than 60% by mass, not only a poor workability will be exhibited due to a higher viscosity of the composition, and the mechanical strength of the cured product will deteriorate, but there may also be observed a problem where, for example, a sufficient adhesive force cannot be exerted.

Especially, if adding the inorganic filler for the purpose of achieving lower dielectric properties, the dielectric tangent shall be not higher than 0.005, desirably not higher than 0.003, particularly desirably not higher than 0.001, in a frequency band of 10 to 70 GHz.

### Curable Resin Composition Layer

In the curable resin composition layer, any resin may be used so long as it has a heat curability, and there are no particular restrictions imposed thereon. For example, there may be employed a composition containing a curable resin(s) such as an epoxy resin, a cyanate ester resin, a phenolic resin, a bismaleimide-triazine resin, a polyimide resin, an acrylic resin, a vinyl benzyl resin, and a silicone-modified epoxy resin; and a curing agent thereof. If used for the production of a circuit board such as a multilayered printed-wiring board and a flexible printed-wiring board, preferred is a composition containing an epoxy resin and/or a bismaleimide resin, as a curable resin(s). Particularly, more preferred is a composition containing at least an epoxy resin and/or a bismaleimide resin, and a curing agent(s) thereof.

Examples of such epoxy resin include a bisphenol A-type epoxy resin, a bisphenol F-type epoxy resin, a bisphenol S-type epoxy resin, a phenol novolac-type epoxy resin, an alkylphenol novolac-type epoxy resin, a biphenyl-type epoxy resin, an aralkyl-type epoxy resin, a naphthol-type epoxy resin, a dicyclopentadiene-type epoxy resin, a naphthalene-type epoxy resin, an epoxide of a condensate of phenols and a phenolic hydroxyl group-containing aromatic aldehyde, a biphenyl aralkyl-type epoxy resin, a fluorene-type epoxy resin, a xanthene-type epoxy resin, and triglycidyl isocyanurate. One kind of epoxy resin may be used alone, or two or more kinds thereof may be used in combination.

Further, the abovementioned bismaleimide resin is also most suitable for achieving lower dielectric properties and a lower elasticity.

As such bismaleimide resin, the SLK-2000 series (by Shin-Etsu Chemical Co., Ltd.) or the like is also available other than the bismaleimide resin of the formula (1), and the abovementioned SLK-6895 (by Shin-Etsu Chemical Co., Ltd.) and SLK-3000 (by Shin-Etsu Chemical Co., Ltd.). One kind of bismaleimide resin may be used alone, or two or more kinds thereof may be used in combination. Further, the bismaleimide resin and the epoxy resin may be used in a mixed manner in accordance with an intended use as well as a desired property. A mixing ratio can be freely selected in a rang(s) of epoxy resin 0 to 100 parts by mass; and bismaleimide resin 0 to 100 parts by mass.

Examples of the curing agent include an amine-based curing agent, a guanidine-based curing agent, an imidazole-based curing agent, a phenol-based curing agent, a naphthol-based curing agent, an acid anhydride-based curing agent, an epoxy adduct of any of these curing agents, a curing agent prepared by micro-encapsulating any of these curing agents, and a cyanate ester resin. Particularly, preferred are a phenol-based curing agent, a naphthol-based curing agent and a cyanate ester resin. In the present invention, one kind of curing agent may be used alone, or two or more kinds thereof may be used in combination.

If using a phenol-based curing agent or a naphthol-based curing agent, a compounding ratio between the epoxy resin and the curing agent is preferably one at which the phenolic hydroxyl equivalent in these curing agents per 1 epoxy equivalent in the epoxy resin is 0.4 to 2.0, more preferably 0.5 to 1.0. If using a cyanate ester resin, the compounding ratio is preferably one at which the cyanate equivalent per 1 epoxy equivalent is 0.3 to 3.3, more preferably 0.5 to 2. When the equivalent ratio of the reactive group is out of these ranges, a cured product tends to exhibit an impaired mechanical strength and water resistance.

Further, there may be used a curing accelerator for promoting the reaction between the curing agent and the epoxy and cyanate resins. Such curing accelerator may, for example, be an imidazole-based compound and an organic phosphine-based compound, specific examples of which may include 2-methylimidazole, 4-dimethylaminopyridine, and triphenylphosphine. If using a curing accelerator, the curing accelerator is preferably used in an amount of 0.1 to 3.0 parts by mass with respect to the epoxy resin. Here, if using a cyanate ester resin as the epoxy resin curing agent, for the purpose of shortening a curing time, there may also be added an organic metal compound that has been conventionally used as a curing catalyst in a system employing both an epoxy resin composition and a cyanate compound.

Examples of such organic metal compound include an organic copper compound such as copper(II) acetylacetonate; an organic zinc compound such as zinc(II) acetylacetonate; and an organic cobalt compound such as cobalt(II) acetylacetonate and cobalt(III) acetylacetonate.

The organic metal compound is preferably added in an amount of 10 to 500 ppm, more preferably 25 to 200 ppm, in terms of metal with respect to the cyanate ester resin.

If using a bismaleimide resin involving no reaction of epoxy groups, there may be used the abovementioned peroxide such as dicumyl peroxide, t-butyl peroxybenzoate, t-amyl peroxybenzoate, dibenzoyl peroxide, and dilauroyl peroxide.

As is the case with the curable adhesive composition, the curable resin composition may contain an inorganic filler for achieving a lower thermal expansion of the cured product of the composition. Examples of such inorganic filler include silica, alumina, mica, a silicate salt, barium sulfate, magnesium hydroxide and titanium oxide, of which preferred are silica and alumina, and particularly preferred is silica. The inorganic filler may be spherical or crushed particles. Particularly, a spherical silica made of a molten silica is preferred; while those having an average particle size of not larger than 10 μm will suffice, an average particle size of 0.1 to 5 μm is preferred, and a finer average particle size of not larger than 0.6 μm is even more preferred, in terms of insulation reliability, thicknesses of the resin and adhesion layers, and appearance. In the meantime, while there are no particular restrictions on the lower limit of the average particle size, it is preferred that the average particle size be 0.1 μm or larger. An average particle size of smaller than 0.1 μm may lead to a poor workability due to the occurrence of thixotropy that is triggered by a larger surface area of the particles.

An inorganic filler whose surface has been treated with the aforementioned silane coupling agent is preferred as the surface of the inorganic filler and the resin can thus be strongly bonded together.

Such inorganic filler is added in an amount of 0.2 to 10.0 parts by mass, particularly preferably 1.0 to 5.0 parts by mass, per 100 parts by mass of a total amount of the heat curable resin(s). With an added amount of smaller than 0.2 parts by mass, the resin and the surface of the inorganic filler cannot be strongly bonded together; an added amount of larger than 10 parts by mass may for example cause the coupling agent to ooze out, and lead to a poor appearance due to the occurrence of voids that is triggered by a larger volatilization amount at the time of drying. Here, an added amount of the coupling agent for use in surface treatment as well as a surface treatment method can be appropriately selected, and there are no particular restrictions imposed thereon.

The inorganic filler is preferably contained in the curable resin composition by an amount of 0 to 60% by mass, more preferably 20 to 50% by mass. The absence of an inorganic filler leads to a larger thermal expansion rate of the resin, and thus contributes to peeling due to a thermal stress in the adhesive interface. Further, if the inorganic filler is contained by an amount of larger than 60% by mass, not only a poor workability will be exhibited due to a higher viscosity of the composition, and the mechanical strength of the cured product will deteriorate, but there may also be observed a problem where, for example, a sufficient adhesive force cannot be exerted.

Especially, if adding the inorganic filler for the purpose of achieving lower dielectric properties, the dielectric tangent shall be not higher than 0.005, desirably not higher than 0.003, particularly desirably not higher than 0.001, in a frequency band of 10 to 70 GHz.

When producing a bonding film by performing coating, the curable resin composition and the curable adhesive composition may each be turned into and handled as a varnish by adding an organic solvent, and dissolving the resin component(s) therein.

By turning these compositions into varnishes, not only a film can be formed easily, but they may also each be turned into and used as a bonding film by applying the varnish to a glass cloth made of an E glass, a low-dielectric glass, a quartz glass or the like or impregnating such glass cloth with the varnish, and then drying them.

There are no restrictions on the organic solvent; any organic solvent may be used so long as the resin component(s) can be dissolved therein. For example, there may be listed a ketone-based organic solvent such as methyl ethyl ketone (MEK) and methyl isobutyl ketone (MIBK); a hydrocarbon-based organic solvent such as tetralin, mesitylene, xylene and toluene; anisole; tetrahydrofuran (THF); dimethylformamide (DMF); dimethylsulfoxide (DMSO); and acetonitrile.

If containing the abovementioned maleimide compound, preferred is an aromatic organic solvent such as anisole, tetralin, mesitylene, xylene and toluene. While a ketone-based solvent such as methyl ethyl ketone (MEK) and methyl isobutyl ketone (MIBK) is also often used to obtain a varnish, the usage of such solvent is not preferable when the maleimide compound is contained as this maleimide compound has a low solubility in such ketone-based solvent. Here, one kind of these solvents may be used alone, or two or more kinds of them may be used in combination.

The varnish-like resin composition (resin varnish) may for example be prepared as follows. At first, of the components of the resin composition, those that are soluble in the organic solvent are put into the organic solvent so as to be dissolved therein. At that time, heating may be performed if necessary. Next, components that are insoluble in the organic solvent and are used as appropriate, such as the inorganic filler, are added, and a ball mill, a bead mill, a planetary mixer, a roll mill or the like is then used to disperse them until a given dispersion state has been reached, thereby obtaining a varnish-like resin composition.

A method for producing a film is exemplified hereunder; the production method shall not be limited to the one described below. For example, after applying the curable resin composition dissolved in the organic solvent (varnish) to a base material, heating will be performed at a temperature of normally 80° C. or higher, preferably 100° C. or higher, for 0.5 to 20 min, thereby eliminating the organic solvent so as to obtain a bonding film made of the curable resin composition.

The temperatures in such drying step for eliminating the organic solvent and in a later heating and curing step may each be a constant temperature; however, it is preferred that these temperatures be raised in a stepwise manner. In this way, not only the organic solvent can be efficiently removed from the composition, but the curing reaction of the resin(s) can efficiently proceed as well. As a method for applying the varnish, there may be employed one using a spin coater, a slit coater, a sprayer, a dip coater, a bar coater or the like; there are no particular restrictions on such method.

The base material mentioned here corresponds to the aforementioned support; any support may be used so long as it is a film having a self-supporting property or a sheet-shaped member. There are no particular restrictions on the material of such support; in terms of handling property, cost, versatility, etc., preferred are flexible plastic sheets such as polyethylene terephthalate, polyethylene naphthalate, polyimide, polyamideimide, polyamide, polytetrafluoroethylene, and polycarbonate. Among them, polyethylene terephthalate is particularly preferred as being inexpensive.

The thickness of the coating layer is as above, and a cover film may further be provided on the coating layer as described above. Alternatively, instead of using an organic solvent, the components may be pre-mixed in advance, followed by using a melting and kneading machine to push them out into the shape of a sheet or film so that such sheet or film can be directly used as it is.

A thermoplastic resin may be added to the curable resin composition and the curable adhesive composition to achieve a lower elasticity and impart a strong toughness. Examples of such thermoplastic resin include a phenoxy resin, a polyvinyl acetal resin, a polyimide resin, a polyamideimide resin, a polyether sulfone resin, and a polysulfone resin. As this thermoplastic resin, particularly preferred are a phenoxy resin and a polyvinyl acetal resin. Any one kind of them may be used alone, or two or more kinds of them may be used in combination.

The thermoplastic resin is preferably added at a ratio of 0.5 to 60 parts by mass, more preferably 3 to 40 parts by mass, per 100 parts by mass of the organic resin content in each of the curable resin composition and the curable adhesive composition.

When the ratio of the thermoplastic resin added is smaller than 0.5 parts by mass, the lowering of elasticity may not be realized sufficiently; when the ratio of the thermoplastic resin added is larger than 60 parts by mass, the curable resin composition will exhibit a high melt viscosity, which may make it difficult to embed the resin composition into the wiring patterns on a board.

In the present invention, while there are no particular restrictions on the thickness of the curable resin composition layer, and though depending on a conductor thickness composing the circuit board, the thickness of the curable resin composition layer is about 1 to 100 μm; preferably 10 to 90 μm, more preferably 15 to 80 μm, in terms of insulation reliability between the layers.

In the present invention, as is the case with the curable adhesive composition layer, the curable resin composition layer may be a prepreg prepared by impregnating a sheet-shaped reinforcement base material made of fibers with the curable resin composition. The fibers of the sheet-shaped reinforcement base material may be those that are normally used as fibers for a prepreg, such as a glass cloth, a quartz glass cloth, a carbon fiber woven cloth, and a carbon nanotube unwoven cloth, of which a quartz glass cloth is most preferred as having a small dielectric tangent and exhibiting a low degree of transmission loss.

The prepreg can be formed by impregnating a glass cloth or quartz glass cloth with the curable resin composition or curable adhesive composition via a hot-melt method or a solvent method, and then semi-curing the composition by heating. An impregnation amount and lamination amount of the curable resin composition to the sheet-shaped reinforcement base material is preferably 10 to 200 parts by mass per 100 parts by mass of the reinforcement base material.

A lamination method may for example be one in which the curable resin composition layer and the curable adhesive composition layer are to be sequentially formed on a support; or one in which the curable adhesive composition layer is to be formed on a support film, and there is also prepared a film with the curable resin composition layer formed on a support, followed by bonding together these curable adhesive film and curable resin composition film under a heated condition with the curable resin composition layer and the curable adhesive composition layer being in contact with each other.

As is the case with the abovementioned support, the support film may for example be a plastic film such as a polyethylene terephthalate film and a polyethylene naphthalate film. The plastic film may be one whose surface has been subjected to a surface treatment such as a matt treatment and a corona treatment, and/or a mold release treatment using a mold release agent such as a silicone resin-based mold release agent, an alkyd resin-based mold release agent, and a fluorine resin-based mold release agent.

### Bonding Film for High-Speed Communication Board

There are no particular restrictions on a method for producing the bonding film that is for use in a high-speed communication board and is configured in such a way that laminated on the support are the curable resin composition layer and the curable adhesive composition layer forming an adhesion with a copper foil having a surface roughness of not larger than 1.8 μm.

Further, there are no particular restrictions on a lamination configuration; the bonding film for a high-speed communication board may be one with the curable adhesive composition layer formed on the support being laminated on both surfaces of the curable resin composition layer, or one with multiple curable adhesive composition layer-containing bonding films being laminated on top of one another; and it is preferred that lamination be performed by a lamination process.

There are no particular restrictions on conditions for performing lamination; for example, it is preferred that lamination be performed at a pressure bonding temperature (lamination temperature) of preferably 70 to 140° C., at a pressure bonding pressure of preferably 1 to 11 kgf/cm² (9.8×10⁴ to 107.9×10⁴ N/m²), and under a reduced pressure of not higher than 20 mmHg (26.7 hPa) in terms of air pressure. Particularly, it is preferable to perform lamination under a reduced pressure by a vacuum lamination method. Also, lamination may be performed in a batch-wise manner or in a continuous manner with the aid of a roll.

Vacuum lamination may be carried out using a commercially available vacuum laminator. Examples of such commercially available vacuum laminator include a batch-type vacuum pressure laminator MVLP-500 (by MEIKI CO., LTD.), a vacuum applicator (by Nichigo-Morton Co., Ltd.), a vacuum pressure laminator (by MEIKI CO., LTD.), a roll-type dry coater (by Hitachi Industries Co., Ltd.), and a vacuum laminator (by Hitachi AIC, Inc.).

The bonding film of the present invention for a high-speed communication board is suitable for the production of, for example, a multi-layer board or antenna board intended for high-speed communication that utilizes millimeter waves and terahertz waves and requires an extremely low degree of transmission loss.

Further, the curable adhesive composition layer is at least laminated on one surface of the curable resin composition layer, and may be laminated on both surfaces of the curable resin composition layer.

### WORKING EXAMPLES

The present invention is described in detail hereunder with reference to working examples; the present invention shall not be limited to the following working examples.

### Production of Curable Resin Composition

Here, 5 parts by mass of a bisphenol F-type epoxy resin (jER-1750 by Mitsubishi Chemical Corporation, epoxy equivalent 159), 5 parts by mass of a bisphenol A-type epoxy resin (jER-1001 by Mitsubishi Chemical Corporation, epoxy equivalent 475), 100 parts by mass of a bismaleimide resin (SLK-6895 by Shin-Etsu Chemical Co., Ltd.), and 5 parts by mass of a phenoxy resin (YX7553BH30 by Mitsubishi Chemical Corporation, solution with a solid content of 30% by mass (solution where cyclohexanone:methyl ethyl ketone (MEK) is 1:1)), were heated and dissolved into a mixed solvent of 20 parts by mass of solvent naphtha and 5 parts by mass of cyclohexanone while performing stirring. After cooling the stirred product to room temperature, there were mixed thereinto 5 parts by mass of a triazine frame-containing phenol novolac-based curing agent (hydroxyl equivalent 125, LA-7054 by DIC Corporation, MEK solution with a solid content of 60%), 10 parts by mass of a triazine frame-containing cresol novolac-based curing agent (hydroxyl equivalent 151, LA-3018-50P by DIC Corporation, 2-methoxy propanol solution with a solid content of 50%), 10 parts by mass of a naphthol-based curing agent (SN485 by NIPPON STEEL & SUMIKIN CHEMICAL CO., LTD., hydroxyl equivalent 215, MEK solution with a solid content of 60%), 1 part by mass of an amine-based curing accelerator (4-dimethylaminopyridine (DMAP), MEK solution with a solid content of 5% by mass), and 50 parts by mass of a spherical silica (average particle size 0.5 μm, specific surface area 5.8 m²/g, SO-C2 by ADMATECHS COMPANY LIMITED) that had been subjected to a surface treatment using a phenylaminosilane-based coupling agent (KBM573 by Shin-Etsu Chemical Co., Ltd.), followed by using a high-speed rotating mixer to uniformly disperse them, and then performing filtration using a cartridge filter (SHP100 by ROKI TECHNO CO., LTD.), thereby obtaining a curable resin composition (1).

### Production of Curable Adhesive Composition

(1) 100 parts by mass of a bismaleimide resin (SLK-3000 by Shin-Etsu Chemical Co., Ltd.), 2.0 parts by mass of a curing catalyst (PERCUMYL D, dicumylperoxide by NOF CORPORATION), and 0.5 parts by mass of a silane coupling agent (KBM-803 by Shin-Etsu Chemical Co., Ltd.) were uniformly dispersed into 525 parts by mass of MEK with a high-speed rotating mixer, followed by performing filtration using a cartridge filter (SHP100 by ROKI TECHNO CO., LTD.), thereby obtaining a curable adhesive composition (1).

(2) 100 parts by mass of a bismaleimide resin (SLK-3000 by Shin-Etsu Chemical Co., Ltd.), 10 parts by mass of a bisphenol F-type epoxy resin (jER-1750 by Mitsubishi Chemical Corporation, epoxy equivalent about 159), 1.0 part by mass of a curing catalyst (C11Z-CN, 1-cyanoethyl-2-undecylimidazole by SHIKOKU KASEI HOLDINGS CORPORATION), and 0.5 parts by mass of a silane coupling agent (KBM-903 by Shin-Etsu Chemical Co., Ltd.) were uniformly dispersed into 578 parts by mass of MEK with a high-speed rotating mixer, followed by performing filtration using a cartridge filter (SHP100 by ROKI TECHNO CO., LTD.), thereby obtaining a curable adhesive composition (2).

(3) 50 parts by mass of a bismaleimide resin (SLK-3000 by Shin-Etsu Chemical Co., Ltd.), 40 parts by mass of a bismaleimide resin (SLK-6895 by Shin-Etsu Chemical Co., Ltd.), 10 parts by mass of a bisphenol F-type epoxy resin (jER-1750 by Mitsubishi Chemical Corporation, epoxy equivalent about 159), 1.0 part by mass of a curing catalyst (C11Z-CN, 1-cyanoethyl-2-undecylimidazole by SHIKOKU KASEI HOLDINGS CORPORATION), and 0.5 parts by mass of a silane coupling agent (KBM903 by Shin-Etsu Chemical Co., Ltd.) were uniformly dispersed into 578 parts by mass of MEK with a high-speed rotating mixer, followed by performing filtration using a cartridge filter (SHP100 by ROKI TECHNO CO., LTD.), thereby obtaining a curable adhesive composition (3).

(4) 100 parts by mass of a bismaleimide resin (SLK-3000 by Shin-Etsu Chemical Co., Ltd.), 40 parts by mass of an inorganic filler (SO-25R by ADMATECHS COMPANY LIMITED (average particle size 0.5 μm)), 2.0 parts by mass of a curing catalyst (PERCUMYL D, dicumylperoxide by NOF CORPORATION), and 0.5 parts by mass of a silane coupling agent (KBM803 by Shin-Etsu Chemical Co., Ltd.) were uniformly dispersed into 525 parts by mass of MEK with a high-speed rotating mixer, followed by performing filtration using a cartridge filter (SHP100 by ROKI TECHNO CO., LTD.), thereby obtaining a curable adhesive composition (4).

### Production of Curable Resin Layer Film

### (Reference Example 1) Production of Curable Resin Layer Film (1)

A die coater was used to uniformly apply the curable resin composition (1) to a PET film that had been subjected to a mold release treatment using an alkyd resin-based mold release agent (AL-5 by LINTEC Corporation) (Lumirror R80 by TORAY INDUSTRIES, INC., thickness 38 μm, softening point 130° C., “mold release treatment PET film”) in a manner such that the thickness of a resin composition layer after drying would be 50 μm, followed by performing drying at 120° C. for 5 min to obtain an uncured curable resin composition layer (1) (curable resin layer film (1)).

### (Reference Example 2) Production of Curable Resin Layer Film (2)

A mold release treatment PET film was prepared in a similar manner as the reference example 1. On such PET film, a quartz glass cloth having a filament diameter of 5.0 μm, a thickness of 45 μm and a cloth weight of 42.5 g/m² was impregnated with the curable resin composition (1) in a manner such that the thickness of a curable resin composition layer after drying would be 60 μm, thereby obtaining a curable resin composition layer (2) (curable resin layer film (2)).

### Production of Curable Adhesive Composition Layer

### (Reference Example 3) Production of Curable Adhesive Composition Layer Film (1)

A mold release treatment PET film was prepared in a similar manner as the reference example 1. A die coater was used to uniformly apply the curable adhesive composition (1) to such mold release treatment PET film in a manner such that the thickness of an adhesive composition layer after drying would be 20 μm, followed by performing drying at 120° C. for 5 min to obtain an uncured curable adhesive composition layer (1) (curable adhesive composition layer film (1)).

### (Reference Example 4) Production of Curable Adhesive Composition Layer Film (2)

Using the curable adhesive composition (2), and in a similar manner as the reference example 3, an uncured curable adhesive composition layer (2) (curable adhesive composition layer film (2)) was produced at a thickness of 20 km.

### (Reference Example 5) Production of Curable Adhesive Composition Layer Film (3)

Using the curable adhesive composition (3), and in a similar manner as the reference example 3, an uncured curable adhesive composition layer (3) (curable adhesive composition layer film (3)) was produced at a thickness of 10 km.

### (Reference Example 6) Production of Curable Adhesive Composition Layer Film (4)

Using the curable adhesive composition (3), and in a similar manner as the reference example 3, an uncured curable adhesive composition layer (4) (curable adhesive composition layer film (4)) was produced at a thickness of 10 μm.

### (Reference Example 7) Production of Curable Adhesive Composition Layer Film (5)

Using the curable adhesive composition (1), and in a similar manner as the reference example 3, an uncured curable adhesive composition layer (5) (curable adhesive composition layer film (5)) was produced at a thickness of 110 μm.

### (Reference Example 8) Production of Curable Adhesive Composition Layer Film (6)

A coater was used to apply the curable adhesive composition (1) to a PET film, followed by using a hot air drying furnace to eliminate the solvent by raising the temperature from room temperature to 120° C. at a temperature rising rate of 3° C./sec, thereby obtaining, on the PET film, an uncured curable adhesive composition layer (6) (curable adhesive composition layer film (6)) having a thickness of 0.5 μm.

### (Reference Example 9) Production of Curable Adhesive Resin Layer Prepreg (7)

A coater was used to impregnate a quartz glass cloth having a filament diameter of 5.0 μm, a thickness of 45 μm and a cloth weight of 42.5 g/m² with the curable adhesive composition (4) so as to obtain a curable resin composition layer (7) (curable resin layer film (7)).

### Working Example 1

Lamination was carried out in such way that a surface of the uncured curable adhesive composition layer (1) (curable adhesive composition film (1)) formed on the mold release treatment PET film in the reference example 3 that was not bonded to the PET film was bonded to a surface of the uncured curable resin composition layer (1) (curable resin film (1)) formed on the mold release treatment PET film in the reference example 1 that was not bonded to the PET film.

A batch-type vacuum pressure laminator (by Nikko-Materials Co., Ltd.) was used to treat so as to laminate the resin films which were the resin composition layer film having the thickness of 50 μm and the adhesive composition layer film having the thickness of 20 μm (each being a quadrangle of a size of 150×100 μmm). The lamination process was conducted in a such a manner that after the atmospheric pressure was reduced to 13 hPa or lower by performing depressurization for 30 sec, pressure bonding was carried out at a temperature of 100° C. and a pressure of 0.74 MPa for 30 sec to obtain a bonding sheet (1).

In this way, there was obtained a bonding sheet composed of, and in the order of, the mold release treatment film (PET), the curable resin film (1), the curable adhesive composition film (1), and the mold release treatment film (PET).

### Working Example 2

Lamination was carried out in such way that a surface of the uncured curable adhesive composition layer (2) (curable adhesive composition film (2)) formed on the mold release treatment PET film in the reference example 4 that was not bonded to the PET film was bonded to a surface of the uncured curable resin composition layer (1) (curable resin film (1)) formed on the mold release treatment PET film in the reference example 1 that was not bonded to the PET film.

The lamination of the resin layers was carried out in a similar manner as the working example 1 using a batch-type vacuum pressure laminator, whereby a bonding sheet (2) was obtained.

### Working Example 3

Lamination was carried out in such way that a surface of the uncured curable adhesive composition layer (3) (curable adhesive composition film (3)) formed on the mold release treatment PET film in the reference example 5 that was not bonded to the PET film was bonded to a surface of the uncured curable resin composition layer (1) (curable resin film (1)) formed on the mold release treatment PET film in the reference example 1 that was not bonded to the PET film.

The lamination of the resin layers was carried out in a similar manner as the working example 1 using a batch-type vacuum pressure laminator, whereby a bonding sheet (3) was obtained.

### Working Example 4

Lamination was carried out in such way that a surface of the uncured curable adhesive composition layer (1) (curable adhesive composition film (1)) formed on the mold release treatment PET film in the reference example 3 that was not bonded to the PET film was bonded to a surface of the curable resin composition layer (2) (curable resin layer film (2)) formed on the mold release treatment PET film in the reference example 2 that was not bonded to the PET film.

The lamination of the resin layers was carried out in a similar manner as the working example 1 using a batch-type vacuum pressure laminator, whereby a bonding sheet (4) was obtained.

### Working Example 5

Lamination was carried out in such way that a surface of the uncured curable adhesive composition layer (4) (curable adhesive composition film (1)) formed on the mold release treatment PET film in the reference example 6 that was not bonded to the PET film was bonded to a surface of the curable resin composition layer (1) (curable resin layer film (4)) formed on the mold release treatment PET film in the reference example 1 that was not bonded to the PET film.

The lamination of the resin layers was carried out in a similar manner as the working example 1 using a batch-type vacuum pressure laminator, whereby a bonding sheet (5) was obtained.

### Working Example 6

Lamination was carried out in such way that a surface of the uncured curable adhesive composition layer (7) (curable adhesive composition film (1)) formed on the mold release treatment PET film in the reference example 9 that was not bonded to the PET film was bonded to a surface of the curable resin composition layer (1) (curable resin layer film (4)) formed on the mold release treatment PET film in the reference example 1 that was not bonded to the PET film.

The lamination of the resin layers was carried out in a similar manner as the working example 1 using a batch-type vacuum pressure laminator, whereby a bonding sheet (6) was obtained.

### Comparative Example 1

Lamination was carried out in such way that a surface of the curable adhesive composition layer (5) (curable adhesive composition film (5)) formed on the mold release treatment PET film in the reference example 7 that was not bonded to the PET film was bonded to a surface of the uncured curable resin composition layer (1) (curable resin film (1)) formed on the mold release treatment PET film in the reference example 1 that was not bonded to the PET film.

The lamination of the resin layers was carried out in a similar manner as the working example 1 using a batch-type vacuum pressure laminator, whereby a bonding sheet (7) was obtained.

### Comparative Example 2

Lamination was carried out in such way that a surface of the curable adhesive composition layer (6) (curable adhesive composition film (6)) formed on the mold release treatment PET film in the reference example 8 that was not bonded to the PET film was bonded to a surface of the uncured curable resin composition layer (1) (curable resin film (1)) formed on the mold release treatment PET film in the reference example 1 that was not bonded to the PET film.

The lamination of the resin layers was carried out in a similar manner as the working example 1 using a batch-type vacuum pressure laminator, whereby a bonding sheet (8) was obtained.

Adhesion Strength Test with Copper Foil

An adhesion strength of each bonding sheet to a copper foil was evaluated. Each bonding sheet was cut into a size of 10 mm×76 mm, and a film (bonding film) obtained by removing the supports from this sheet was then pressure-bonded together with a copper foil (thickness: 18 μm, surface roughness 1.0 μm) and a glass with the adhesive layer facing the copper foil and the resin layer facing the glass, using a batch-type vacuum pressure laminator (CVP700, 2-stage build-up laminator by Nikko-Materials Co., Ltd.). Specifically, after the atmospheric pressure was reduced to 13 hPa or lower by performing depressurization for 30 sec, pressure bonding was carried out at a temperature of 120° C. and a pressure of 0.74 MPa for 30 sec with the bonding film being interposed between the copper foil and the glass. After bonding, the bonded product was then treated at 180° C. for 2 hours so as to be cured, thus obtaining a test sample.

An adhesion strength to the copper foil was measured by performing a 900 peel strength test on the test sample, where an autograph (AG-IS by Shimadzu Corporation) was used to conduct the measurement at a rate of 50 mm/min. The results thereof are shown in Table 1.

An adhesion strength between the curable resin composition layer and the curable adhesive composition layer was evaluated visually. Here, “o” was given to examples where there were observed a high adhesion and an adherend failure due to the satisfactory adhesion strength; “x” was given to examples where while the layers were bonded to each other, interfacial peeling occurred due to an unsatisfactory adhesion strength.

TABLE 1

| | | Adhesion between |
|---|---|---|
| | Adhesion strength to | adhesive layer and |
| | copper foil (kN/m) | resin composition layer |
| Working example 1 | 0.9 | ◯ |
| Working example 2 | 1.5 | ◯ |
| Working example 3 | 1.2 | ◯ |
| Working example 4 | 1.6 | ◯ |
| Working example 5 | 1.8 | ◯ |
| Working example 6 | 1.8 | ◯ |
| Comparative example 1 | 1.6 | X |
| Comparative example 2 | 0.2 | X |

What is claimed is:

1. A curable adhesive layer-containing bonding film for a high-speed communication board, comprising:
a curable resin composition layer containing a curable resin composition; and
a curable adhesive composition layer that is laminated on one or both surfaces of the curable resin composition layer, contains a bismaleimide resin-containing curable adhesive composition, and has a thickness of 1 to 100 μm.

2. The bonding film for a high-speed communication board according to claim 1, wherein the bismaleimide resin includes a bismaleimide resin represented by the following formula (1): 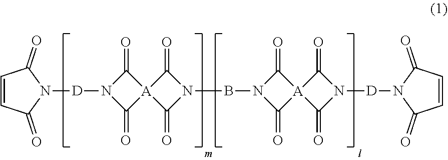
wherein A independently represents a tetravalent organic group having a cyclic structure; B independently represents a divalent hydrocarbon group having 6 to 60 carbon atoms; D independently represents a divalent hydrocarbon group having 6 to 200 carbon atoms, where at least one D represents a dimer acid frame-derived hydrocarbon group; m is 0 to 100, and l is 0 to 200, where m=l=0 is also included; no restrictions are imposed on an order of each repeating unit identified by m and l, and a bonding pattern may be alternate, block or random.

3. The bonding film for a high-speed communication board according to claim 1, wherein the curable adhesive composition is capable of adhering to a copper foil having a surface roughness (Rz) of not larger than 1.8 μm.

4. The bonding film for a high-speed communication board according to claim 2, wherein the curable adhesive composition contains an inorganic filler.

5. The bonding film for a high-speed communication board according to claim 1, wherein the curable adhesive composition layer is a prepreg with a quartz glass cloth being impregnated with a curable adhesive composition containing a bismaleimide resin represented by the following formula (1) and an inorganic filler 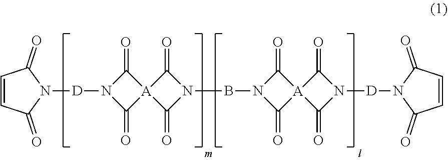
wherein A independently represents a tetravalent organic group having a cyclic structure; B independently represents a divalent hydrocarbon group having 6 to 60 carbon atoms; D independently represents a divalent hydrocarbon group having 6 to 200 carbon atoms, where at least one D represents a dimer acid frame-derived hydrocarbon group; m is 0 to 100, and l is 0 to 200, where m=l=0 is also included; no restrictions are imposed on an order of each repeating unit identified by m and l, and a bonding pattern may be alternate, block or random.

6. The bonding film for a high-speed communication board according to claim 5, wherein the prepreg has a dielectric tangent of not larger than 0.002 at 10 GHz.

7. The bonding film for a high-speed communication board according to claim 1, wherein the curable adhesive composition layer has a thickness of 1 to 50 km.

8. The bonding film for a high-speed communication board according to claim 1, wherein the curable resin composition contains an epoxy resin and/or a bismaleimide resin; and a curing agent.

9. The bonding film for a high-speed communication board according to claim 1, wherein the curable resin composition layer has a thickness of 1 to 100 μm.

10. The bonding film for a high-speed communication board according to claim 1, wherein the curable resin composition layer is a prepreg with a quartz glass cloth being impregnated with a curable resin composition.

11. The bonding film according to claim 1 with the curable adhesive composition layer being laminated on one surface of the curable resin composition layer, wherein
a support is provided on a surface of the curable resin composition layer that is not in contact with the curable adhesive composition layer, and
another support is provided on a surface of the curable adhesive composition layer that is not in contact with the curable resin composition layer.

12. The bonding film for a high-speed communication board according to claim 11, wherein the support is a polyethylene terephthalate film.

13. The bonding film for a high-speed communication board according to claim 12, wherein the support has a thickness of 10 to 70 μm.

14. A method for producing a bonding film for a high-speed communication board, comprising a step of laminating a curable resin composition layer formed on a support and a curable adhesive composition layer formed on a support.
